(19) United States
(12) Patent Application Publication
(10) Pub. No.: US 2024/0314151 A1
(43) Pub. Date: Sep. 19, 2024

(54) DETECTING ANOMALOUS ACTIVITY IN A SYSTEM-ON-CHIP

(71) Applicant: INTERNATIONAL BUSINESS MACHINES CORPORATION, Armonk, NY (US)

(72) Inventors: Naorin Hossain, Secaucus, NJ (US); Alper Buyuktosunoglu, White Plains, NY (US); John-David Wellman, Hopewell Junction, NY (US); Pradip Bose, Yorktown Heights, NY (US)

(21) Appl. No.: 18/185,318

(22) Filed: Mar. 16, 2023

(51) Int. Cl. H04L 9/40

(52) U.S. Cl. CPC H04L 63/1425; H04L 63/1441

(57) ABSTRACT

Provided are a computer program product, system, and method for detecting anomalous activity in a system-on-chip. Counter values are determined from counters for processing elements in the system-on-chip during a test workload. A counter for one of the processing elements indicates an amount of activity at a processing element during a measurement period. An anomaly detector is trained to classify the determined counter values during measurement periods occurring during the test workload as non-anomalous activity. The trained anomaly detector is deployed within the system-on-chip to process counter values in the counters for the processing elements on the system-on-chip to classify the counter values as anomalous or non-anomalous. A mitigation action is performed in response to the deployed trained anomaly detector detecting the anomalous activity within the system-on-chip.

This invention was made with government support under Government Contract #HR-0011-18-C-0122 awarded by Defense Advanced Research Projects Agency (DARPA). The government has certain rights to this invention.

### BACKGROUND OF THE INVENTION

### 1. Field of the Invention

The present invention relates to a computer program product, system, and method for detecting anomalous activity in a system-on-chip.

### 2. Description of the Related Art

System-on-chip and network-on-chip devices are deployed in computing environments requiring low-power and high computing demands, often in edge devices. Systems-on-chip devices have been increasingly targeted with malicious malware attacks including eavesdropping, spoofing/data integrity, denial-of-service (DOS), buffer overflow/memory extraction, and side-channels. These attacks may be launched maliciously via hardware trojans injected during design/fabrication time or malware loaded on the system, e.g., via system updates.

DOS attacks prevent a system from performing as expected by flooding parts of the system with unnecessary tasks to increase latency. DOS attacks slow down the system and can prevent meeting real-time deadlines. Current techniques for detecting malicious processes compare executing processes and their activity patterns to a stored signature or pattern of known past malicious processes. However, such techniques lack the ability to detect new malicious processes just introduced.

There is a need in the art to provide improved techniques for detecting anomalies in system-on-chip devices.

### SUMMARY

Provided are a computer program product, system, and method for detecting anomalous activity in a system-on-chip. Counter values are determined from counters for processing elements in the system-on-chip during a test workload. A counter for one of the processing elements indicates an amount of activity at a processing element during a measurement period. An anomaly detector is trained to classify the determined counter values during measurement periods occurring during the test workload as non-anomalous activity. The trained anomaly detector is deployed within the system-on-chip to process counter values in the counters for the processing elements on the system-on-chip to classify the counter values as anomalous or non-anomalous. A mitigation action is performed in response to the deployed trained anomaly detector detecting the anomalous activity within the system-on-chip.

### BRIEF DESCRIPTION OF THE DRAWINGS

FIG. 1 illustrates an embodiment of a system-on-chip with a network-on-chip.

FIG. 2 illustrates an embodiment of an anomaly detector within the system-on-chip.

FIG. 3 illustrates an embodiment of operations to train an anomaly detector in a system-on-chip.

FIG. 4 illustrates an embodiment of operations performed by the anomalous detector to detect anomalous activity in the system-on-chip.

FIG. 5 illustrates an embodiment of operations to mitigate a determination of anomalous activity.

FIG. 6 illustrates an embodiment of a connected autonomous vehicle system-on-chip.

FIG. 7 illustrates an environment of connected autonomous vehicles implementing the system-on-chip of FIG. 6.

### DETAILED DESCRIPTION

In the current art, malware detectors do not monitor activity throughout the system-on-chip and only monitor processor-specific activity. Further, using malware detection methods that are based on signature matching is unable to detect novel attacks for which there are no stored signatures. Further, current malware detection techniques are not designed to meet the real-time deadline requirements of heterogeneous system-on-chip processing.

The described embodiments provide computer technology for implementing an anomaly detector on the system-on-chip that is able to monitor activity throughout the system-on-chip, capable of distinguishing anomalous activity despite high variability in regular workload activity, and that is agnostic as to the operations and components on the system-on-chip, including those with heterogeneous components for which existing detection techniques are not sufficient.

With described embodiments, the anomaly detection is at the network-on-chip interconnect level and is generic and applicable to any processing elements and tile mixes that may be implemented on the system-on-chip and connected to the network-on-chip on the system-on-chip. Described embodiments access counters in the network-on-chip hardware that monitor activity in the processing elements of the system-on-chip. Fast semi-supervised or unsupervised machine learning models are deployed to classify a counter vector, from counter values from the counters in the network-on-chip hardware, as anomalous or non-anomalous.

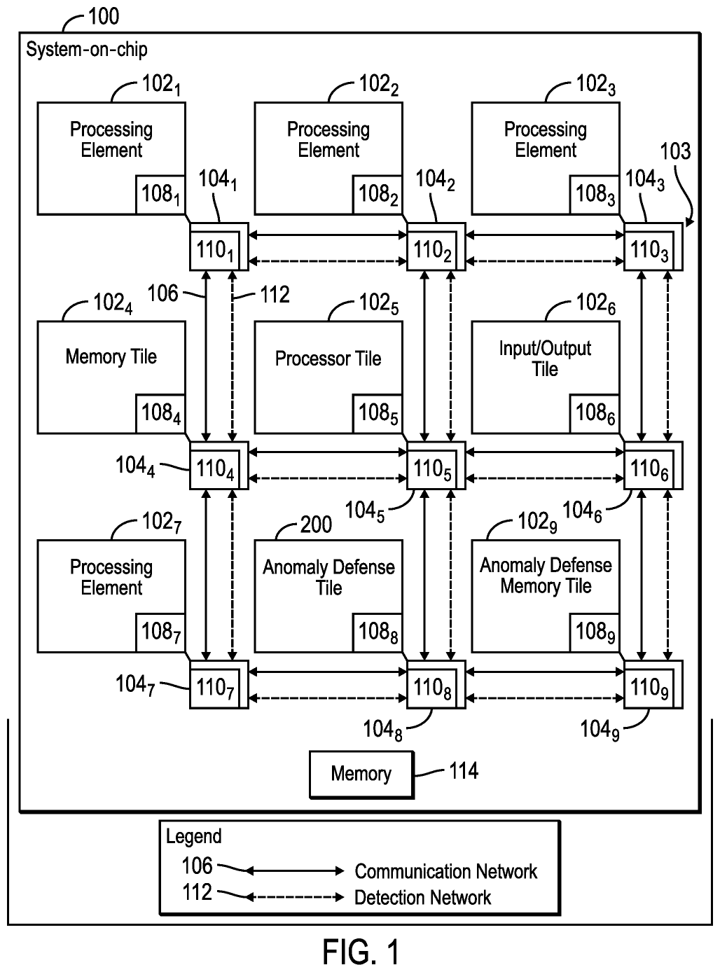

FIG. 1 illustrates an embodiment of a system-on-chip 100 having a plurality of processing elements 102₁, 102₂ . . . 102₉ or tiles, including a processor tile 102₅; a memory tile 102₄ used to access and allocate memory resources; an Input/Output (I/O) tile 102₆ used to communicate with other system-on-chips and other systems; an anomaly defense tile 200 used to detect anomalous and potentially malicious activity in the network-on-chip 100; and an anomaly defense memory tile 102₉ dedicated solely to the anomaly defense tile 200 operations. In further embodiments, in addition to or instead of having a dedicated memory tile 102₉, the anomaly defense tile 200 may use a local scratchpad memory within the tile 200.

The system-on-chip includes a network-on-chip 103 to interconnect the processing elements 102₁, 102₂ . . . 102₉. The network-on-chip 103 is implemented in routers 104₁, 104₂ . . . 104₉ that provide a mesh network 106 on which the processing elements 102₁, 102₂ . . . 102₉ communicate. Each processing element 102; is connected via a line to a hardware router 104; that forms a communication network 106 among the processing elements 102₁, 102₂ . . . 102₉ to allow transmission of packets of request and responses among the processing elements 102₁, 102₂ . . . 102₉. The network 106 may comprise a packet-switched fabric for on-chip communication.

Each of the processing elements 102; include a network interface 108; to communicate packets of requests and responses to other tiles via the routers 104₁, 104₂ . . . 104₉. The routers 104₁, 104₂ . . . 104₉ may provide the application layer, transport layer, physical layer, network layer, and data link layer protocols to communicate packets among the routers 104₁, 104₂ . . . 104₉. The combination of the network interfaces 108₁, 108₂ . . . 108₉, routers 104₁, 104₂ . . . 104₉, and wires connecting the routers 104₁, 104₂ . . . 104₉ enable point-to-point communication over the networks 106, 112, to exchange data directly.

Each of the routers 104i includes one or more counters 110ᵢ to count activity at the processing element 102ᵢ. The counters 110; may count different measurement types for different processing element types. For instance, a counter 110₅, 110₈ for a processor 102₅ tile and accelerator tile 200, respectively, measures processing cycles during a measurement period, such as total cycles run to respond to a request; a counter 110₄, 110₉ for a memory tile 102₄, 102₉ indicates a number of memory requests to the memory tile, such as off-chip memory accesses, Direct Memory Access (DMA) requests/responses, and coherence requests/responses sent through the network-on-chip 103; and a counter 110₆ for an I/O tile 102₆ measures packets-in and packets-out of the I/O tile 102₆.

Each of the routers 104ᵢ is capable of forming two or more mesh network planes for the network-on-chip 103 where the routers 104₁, 104₂ . . . 104₉ are connected via wires, including one or more communication network planes 106 comprising the communication network among the processing elements 102₁, 102₂ . . . 102₉ and a detection network plane 112 comprising a network only the anomaly defense tile 200 uses to read the counter values from the counters 110₁, 110₂ . . . 110₉. In this way, the communication network plane 106 and the detection network plane 112 are separate and have different communication lines, but share the same routers 104₁, 104₂ . . . 104₉. The network planes 106, 112 are s formed of wires connecting the routers 104₁, 104₂ . . . 104₉ to form the interconnecting mesh.

In certain embodiments, the processing elements 102₁, 102₂ . . . 102₉ may comprise tiles, such as processor tiles, accelerator tiles, memory tiles for the communication with main memory, and auxiliary tile for peripherals, such as Universal Asynchronous Receiver/Transmitter (UART) and Ethernet, or system utilities, like an interrupt controller and the timer. The content of each tile is encapsulated into a modular socket or shell, which interfaces the tile to the network-on-chip and implements the platform services. The socket-based approach, which decouples the design of a tile from the design of the rest of the system, allows the modular tiles to be replaced and be accessible through the tile layers and router 104; to which the tile connects.

The processor tile 102₅ contains a processor core, an L1 and L2 caches, and a local bus. Processor memory requests are forwarded by a socket layer in the network interface 108₅ to the network 106. Each memory tile 102₄ 102₉ provides a channel to external memory 114, such as a Dynamic Random Access Memory (DRAM) and hardware logic to support portioning of addressable memory space. The accelerator tiles, such as anomaly defense tile engine tile 200 implements specialized hardware to execute tasks independent of other processors 102₅ and accelerator tiles. The I/O tile 102₆ hosts shared peripherals in the system, such as Ethernet, Network Interface Card (NIC), UART, digital video interface, etc. General processing element tiles 102₁, 102₂, 102₃, 102₇ may comprise any one of processor, memory, accelerator, and I/O tiles to perform the operations for which the system-on-chip 100 is deployed.

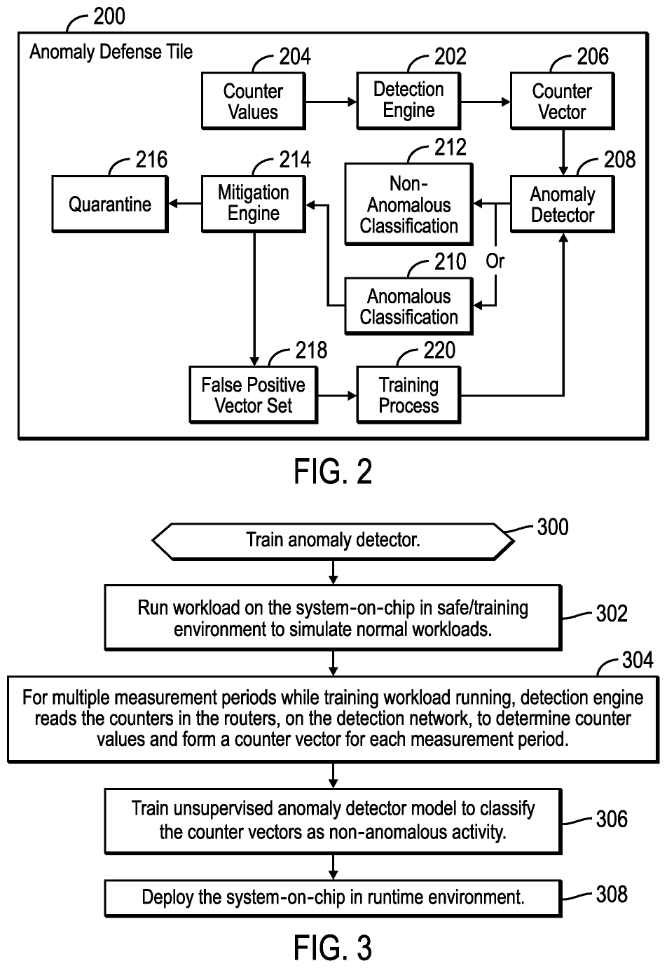

FIG. 2 illustrates an embodiment of the anomaly defense tile 200 including a detection engine 202 that receives counter values 204 read from the counters 110₁, 110₂ . . . 110₉ over the mesh network 106 and generates a counter vector 206. The anomaly detector 208 receives the counter vector 206 and classifies the counter vector 206 as anomalous 210 or non-anomalous 212. An anomalous classification 210 is forwarded to a mitigation engine 214 to determine whether to place a process executing in the network-on-chip 100 that caused the counter values 206 resulting in the anomalous classification in quarantine 216. If the anomalous classification 210 is a false positive, then the counter vector 206 is added to a false positive vector set 218 to forward to a training process 220 to retrain the anomaly detector 208 to classify counter vectors in the false positive vectors set 218 as non-anomalous.

In certain embodiments, the anomaly detector may comprise an unsupervised or semi-supervised anomaly detection model such as one-class nearest neighbors (OCNN), one-class support vector machines (OCSVM), isolation forest (iF), and local outlier factor (LOF). The nearest neighbor algorithms, such as OCNN, OCSVM, and LOF operate by determining whether a distance from a counter vector 206 received during runtime operations is sufficiently close to sample counter vectors considered during training to be classified as non-anomalous. An isolation forest implementation uses counter vectors in a training dataset using recursive partitioning to build an isolation tree. The test set is passed through the isolation tree to assign a non-anomaly score, to mark an anomaly at any point whose score is greater than a threshold.

In certain embodiments, the anomaly detector 208 is trained on regular, expected data and no attack data is needed to train the anomaly detector 208. The anomaly detector 208 provides simple and fast classification.

In a hardware implementation embodiment, as shown in FIG. 1, the detection engine 202, anomaly detector 208, mitigation engine 214, and training process 220 are implemented in special purpose hardware of the anomaly defense tile 200, which stores the false positive vector set 218 and other parameters in the anomaly defense memory tile 102₉. In an alternative software implementation embodiment, the detection engine 202, anomaly detector 208, mitigation engine 214, and training process 220 are implemented in computer program code stored in the anomaly defense memory tile 102₉ and loaded into the anomaly defense tile 200 comprising a processor, operating at a high privilege level, and dedicated to processing anomaly code to execute to perform anomaly detection operations. The anomaly defense tile 102₉ may be dedicated to the anomaly defense tile 200 operations.

The arrows shown in FIG. 1 show the path of wires that interconnect the routers 104₁, 104₂ . . . 104₉ to form the mesh networks 106, 112. The arrows shown in FIG. 2 between the processing elements and objects represent a data flow between the processing elements.

The functions described as performed by the program processing elements of FIGS. 1 and 2, including processing elements 202, 208, 214, 220 may be implemented as program code in fewer program modules than shown or implemented as program code throughout a greater number of program modules than shown.

The system-on-chip 100 may be deployed in different computing environments for different uses.

In alternative embodiments, the counters 110₁, 110₂ . . . 110₉ may be located in other locations of the chip, such 100 as in one or more tiles or in one or fewer than all routers 104j.

FIG. 3 illustrates an embodiment of operations performed by the training process 220 to train the anomaly detector 208. Upon initiating (at block 300) anomaly detector 208 training, the training process 220 runs (at block 302) a workload on the network-on-chip 100 in a safe training environment to simulate normal, non-anomalous workloads. For multiple measurement periods while the training workload is running, the detection engine 202 reads (at block 304) the counters in the routers 104₁, 104₂ . . . 104₉, over the detection network 116, to determine counter values 204 and form a counter vector 206 for each measurement period. The training processor 220 trains (at block 306) the unsupervised or semi-supervised anomaly detector 208 model to classify the counter vectors 206 as non-anomalous activity. The system-on-chip 100 may then be deployed in a runtime environment with the trained anomaly detector 208 to detect anomalies and malicious activity occurring in the system-on-chip. 100.

With the embodiment of FIG. 3, counter values for the counters 110₁, 110₂ . . . 110₉ capture activity in the system-on-chip during a safe and normal workload to use to train the anomaly detector 208 to classify counters 110₁, 110₂ . . . 110₉ indicating activity at the processing elements 102₁, 102₂ . . . 102₉ as anomalous or non-anomalous.

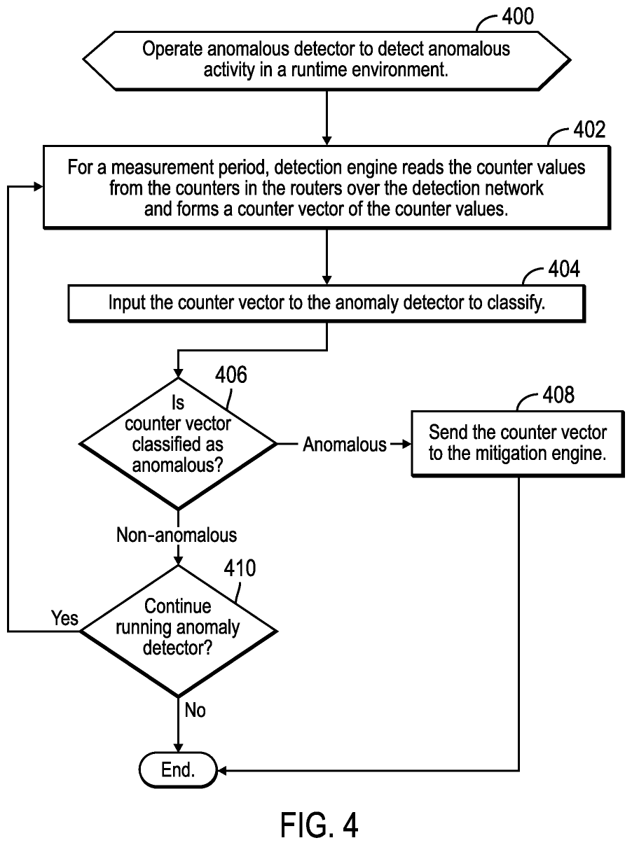

FIG. 4 illustrates an embodiment of operations performed by the anomaly detector 208 to detect anomalies in activity at the processing elements 102₁, 102₂ . . . 102₉ during runtime operations. Upon initiating (at block 400) anomalous detection, for a measurement period, the detection engine 202 reads (at block 402) the counter values from the counters 110₁, 110₂ . . . 110₉ in the routers 104₁, 104₂ . . . 104₉ over the detection network 112 and forms a counter vector 206 of the counter values. The counter vector 206 is inputted (at block 404) to the anomaly detector 208 to classify. If (at block 406) the counter vector 206 is classified as anomalous 210, then the counter vector 206 is sent (at block 408) to the mitigation engine 214. If (at block 406) the counter vector 206 is classified as non-anomalous 212 or from block 408, if (at block 410) the anomaly detector 208 should continue running, then control returns to block 402 to determine the counter vector 206 for a next measurement period to consider. If (at block 410) the anomaly detector is to stop running, then control ends.

With the embodiment of FIG. 4, counter values for counters for all the tiles in a network-on-chip are provided to an anomaly detector 208 to determine whether the counter values indicate anomalous or non-anomalous activity of the processing elements. Further, if the counters 110₁, 110₂ . . . 110₉ are located outside of the tiles, such as in the routers 104₁, 104₂ . . . 104₉, then accessing the counters 110₁, 110₂ . . . 110₉ will not require access to the processing elements 102₁, 102₂ . . . 102₉, and thus not negatively impact processing element operations. Further, in embodiments where the counters 110₁, 110₂ . . . 110₉ are read over a detection network 112, separate from the communication network 106, then reading the counters 110₁, 110₂ . . . 110₉ will not interfere with bandwidth on the network 106 interconnecting the processing elements 102₁, 102₂ . . . 102₉, which use a separate network 106.

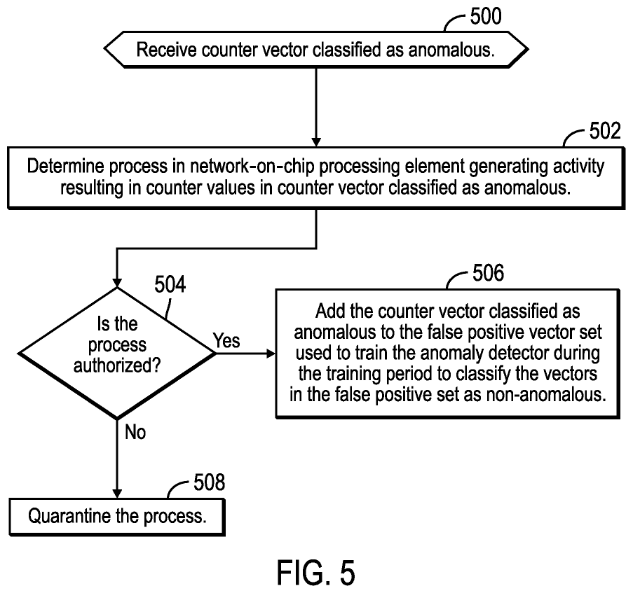

FIG. 5 illustrates an embodiment of operations performed by the mitigation engine 214 to process a counter vector 206 classified as anomalous. Upon receiving (at block 500) a counter vector 206 classified as anomalous, the mitigation engine 214 determines (at block 502) a process executing in the system-on-chip 100 processing element that generates activity resulting in the counter values in the counter vector 206 classified as anomalous. If (at block 504) the process is authorized and not deemed malicious, then the mitigation engine 214 adds (at block 506) the counter vector 206 classified as anomalous to the false positive vector set 218. The training process 220 trains the anomaly detector 208 to classify the counter vectors in the false positive vector set 218 as non-anomalous. Otherwise, if the process was determined (at block 504) to be unauthorized or malicious, then the process is added (at block 508) to the quarantine 216 and blocked from continuing. In quarantine, a user or administrator may be notified of the quarantined process to confirm whether malicious or not, and whether to take further remedial action.

In an alternative embodiment to FIG. 5, there may be no training processor 220 to retrain the anomaly detector 208 based on a false positive vector set 218. In such case, once the anomaly detector 208 is trained on the initial training data set representing a regular and expected workload, there are no further adjustments or training of the anomaly detector 208.

The measurement period during the training period of FIG. 3 and retraining based on a false positive vector set 218 may be set to 100 milliseconds or some other suitable predetermined interval.

With the embodiment of FIG. 5, the mitigation engine 214 determines whether the counters in a counter vector 206 have been wrongly classified as anomalous, i.e., false positive, and then retrain the anomaly detector 208 to classify such wrongly classified counter vectors as non-anomalous to continually improve the detection capability of the anomaly detector 208 so that cycles are not wasted classifying counter vectors as false positive anomalous.

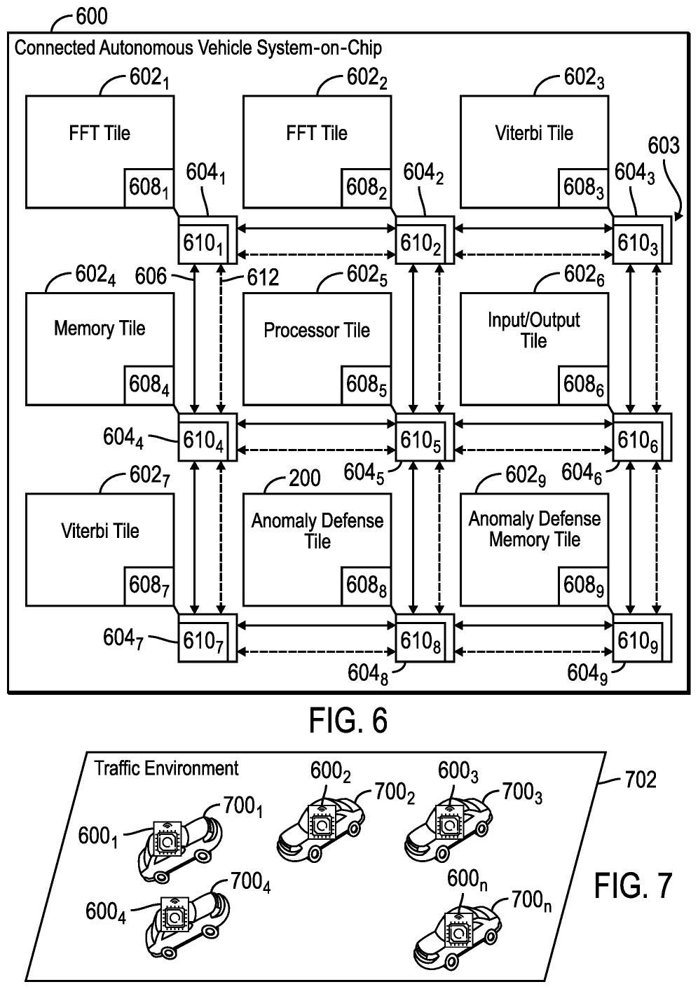

FIG. 6 illustrates an implementation of the anomaly engine in a system-on-chip 600 and network-on-chip 603 for use in connected autonomous vehicle (CAV) communication subsystems. The system-on-chip 600 includes Fast Fourier Transform (FFT) accelerators 6021, 6022 that calculate distance from the vehicle to objects surrounding the vehicle; Viterbi accelerators 6043, 6047, that decode messages from other CAV system-on-chips in other vehicles as part of a smart infrastructure (SWARM) where the CAV system-on-chips 600 communicate to manage traffic flow; and an anomaly defense tile 200 described with respect to FIGS. 1-5, to perform the anomaly detection. The CAV system-on-chip 100 includes routers 6041, 6042 . . . 6049, communication network 606, network interfaces 6081, 6082 . . . 6089, counters 6101, 6102 . . . 6109, and a detection network 612 that correspond and operate as described with respect to components 104₁, 104₂ . . . 104₉, 106, 108₁, 108₂ . . . 108₉, 110₁, 110₂ . . . 110₉, and a network 112, respectively, as described in FIGS. 1-5.

FIG. 7 illustrates how the CAV system-on-chips 600₁, 600₂ . . . 600ₙ may be deployed in vehicles 700₁, 700₂ . . . 700ₙ in a SWARM intelligent traffic environment 702 where the CAV systems-on-chip 600₁, 600₂ . . . 600ₙ intercommunicate to determine distance from other cars and manage traffic flow to avoid accidents.

The CAV vehicles 700₁, 700₂ . . . 700ₙ share data with nearby CAVs and smart infrastructure (“swarm”) to improve reliability of navigational decisions. This data sharing increases the attack surface for possible malware injections that can slow down the system's processing abilities. Malware-injected DOS attacks can substantially increase traffic on SoC components in the CAV, preventing them from functioning properly and satisfying real-time deadlines. Real-world variability from message sharing among CAVs can add complexity in distinguishing between legitimate and anomalous high processing activity.

With the described embodiments, counters in the system-on-chip can track activity through all the processing elements of the CAV system-on-chip, and the anomaly detector can process vectors of the counter values to identify malware DOS attacks and quarantine them to not interfere with the traffic processing operations of the CAV system-on-chip, which interference could threaten traffic safety.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several processing elements in communication with each other does not imply that all such processing elements are required. On the contrary a variety of optional processing elements are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for detecting an anomaly in system-on-chip, the computer program product comprising a computer readable storage medium having computer readable program code embodied therein that is executable to perform operations, the operations comprising:
determining counter values from counters for processing elements in the system-on-chip during a test workload, wherein a counter for one of the processing elements indicates an amount of activity at a processing element during a measurement period;
training an anomaly detector to classify the determined counter values during measurement periods occurring during the test workload as non-anomalous activity;
deploying the trained anomaly detector within the system-on-chip to process counter values in the counters for the processing elements on the system-on-chip to classify the counter values as anomalous or non-anomalous; and
performing a mitigation action in response to the deployed trained anomaly detector detecting the anomalous activity within the system-on-chip.

2. The computer program product of claim 1, wherein the anomaly detector implements an unsupervised or semi-supervised machine learning model, wherein the operations further comprise:
repeatedly retraining the anomaly detector while deployed within the system-on-chip to classify as non-anomalous counter values resulting from known non-anomalous activity and counter values whose classification by the anomaly detector as anomalous comprises a false positive classification.

3. The computer program product of claim 1, wherein the mitigation action comprises:
determining a process, executing in the system-on-chip, producing activity in the system-on-chip that results in the counter values in the counters being classified as anomalous;
determining whether the determined process is an authorized process; and
quarantining the determined process in response to determining the determined process is not authorized.

4. The computer program product of claim 1, wherein the operations further comprise:
determining counter values classified as anomalous activity that is a false positive; and
training the anomaly detector to classify the determined counter values as non-anomalous activity.

5. The computer program product of claim 1, wherein different counters for different processing elements measure different network-on-chip traffic activity at the processing elements based on activity in the system-on-chip.

6. The computer program product of claim 5, wherein the different counters comprise:
a counter for an accelerator that measures processing cycles during a measurement period;
a counter for a memory tile in the system-on-chip indicating a number of memory requests to the memory tile;
a counter for an Input/Output tile that measures packets-in and packets-out of the Input/output tile; and
a general purpose counter for tiles that measure network-on-chip packets-in and packets-out of the tiles.

7. The computer program product of claim 1, wherein the system-on-chip includes a network-on-chip, wherein the network-on-chip includes routers comprising hardware on the network-on-chip to interconnect the processing elements, and wherein the counters are implemented in the routers for the processing elements.

8. The computer program product of claim 7, wherein the operations further comprise:
reading, by the anomaly detector, the counter values for the processing elements from the routers for the processing elements.

9. The computer program product of claim 7, wherein the routers form at least one first network plane and at least one second network plane separate from the at least one first network plane, wherein the processing elements use the at least one first network plane to communicate during workload operations, and wherein the at least one second network plane is used to read the counter values from the counters in the routers that are provided to the anomaly detector.

10. The computer program product of claim 1, wherein the computer readable program code is executed by a processing core tile dedicated to implementing the anomaly detector, and wherein a dedicated anomaly tile stores the anomaly detector loaded into the processing core tile and the determined counter values.

11. The computer program product of claim 1, wherein the computer readable program code and the anomaly detector are implemented in a hardware accelerator tile of the system-on-chip having a dedicated memory tile to store the determined counter values.

12. A system-on-chip for detecting an anomaly, comprising:
a plurality of processing elements;
an anomaly defense tile executing code to perform operations, the operations comprising:
determining counter values from counters for the processing elements in the system-on-chip during a test workload, wherein a counter for one of the processing elements indicates an amount of activity at the processing element during a measurement period;
training an anomaly detector to classify the determined counter values during measurement periods occurring during the test workload as non-anomalous activity;
deploying the trained anomaly detector within the system-on-chip to process counter values in the counters for the processing elements on the system-on-chip to classify the counter values as anomalous or non-anomalous; and
performing a mitigation action in response to the deployed trained anomaly detector detecting the anomalous activity within the system-on-chip.

13. The system-on-chip of claim 12, wherein the operations further comprise:
determining counter values classified as anomalous activity that is a false positive; and
training the anomaly detector to classify the determined counter values as non-anomalous activity.

14. The system-on-chip of claim 12, wherein different counters for different processing elements measure different network-on-chip traffic activity at the processing elements based on activity in the system-on-chip.

15. The system-on-chip of claim 12, wherein the system-on-chip includes a network-on-chip, wherein the network-on-chip includes routers comprising hardware on the network-on-chip to interconnect the processing elements, and wherein the counters are implemented in the routers for the processing elements.

16. The system-on-chip of claim 15, wherein the routers form at least one first network plane and at least one second network plane separate from the at least one first network plane, wherein the processing elements use the at least one first network plane to communicate during workload operations, and wherein the at least one second network plane is used to read the counter values from the counters in the routers that are provided to the anomaly detector.

17. A method for detecting an anomaly in system-on-chip, comprising:
determining counter values from counters for processing elements in the system-on-chip during a test workload, wherein a counter for one of the processing elements indicates an amount of activity at a processing element during a measurement period;
training an anomaly detector to classify the determined counter values during measurement periods occurring during the test workload as non-anomalous activity;
deploying the trained anomaly detector within the system-on-chip to process counter values in the counters for the processing elements on the system-on-chip to classify the counter values as anomalous or non-anomalous; and
performing a mitigation action in response to the deployed trained anomaly detector detecting the anomalous activity within the system-on-chip.

18. The method of claim 17, further comprising:
determining counter values classified as anomalous activity that is a false positive; and
training the anomaly detector to classify the determined counter values as non-anomalous activity.

19. The method of claim 17, wherein the system-on-chip includes a network-on-chip, wherein the network-on-chip includes routers comprising hardware on the network-on-chip to interconnect the processing elements, and wherein the counters are implemented in the routers for the processing elements.

20. The method of claim 19, wherein the routers form at least one first network plane and at least one second network plane separate from the at least one first network plane, wherein the processing elements use the at least one first network plane to communicate during workload operations, and wherein the at least one second network plane is used to read the counter values from the counters in the routers that are provided to the anomaly detector.
